(19) United States
(12) Patent Application Publication
(10) Pub. No.: US 2004/0098711 A1
(43) Pub. Date: May 20, 2004

(54) Method and system for dependence analysis

(76) Inventors: Yonghong Song, Sunnyvale, CA (US); Xiangyun Kong, Fremont, CA (US); Jian-Zhong Wang, Fremont, CA (US)

Correspondence Address: Robert W. Holland, HAMILTON & TERRILE, LLP, PO Box 203518, Austin, TX, 78720, US

(21) Appl. No.: 10/301,384

(22) Filed: Nov. 20, 2002

(51) Int. Cl. G06F 9/45; G06F 9/44

(52) U.S. Cl. 717/150; 717/119

(57) ABSTRACT

Index association based dependence analysis accurately determines lack of dependence for complex memory subscript references to allow greater use of loop transformation and automatic parallelization at compile of an application. Index association functions that map an original i index space to a dependence analysis j index space are analyzed at compile to determine one-to-one mapping or many-to-one mapping. For dependence analysis of two references with a one-to-one mapping determination, lack of dependence in the dependence analysis index space confirms lack of dependence in the original index space. For many-to-one mapping, both a lack of dependence in the dependence analysis index space and a check that no two iterations in the original index space could map to the two references in the dependence analysis index space confirms no dependence for the two references.

### BACKGROUND OF THE INVENTION

1. Field of the Invention

The present invention relates in general to the field of compiling an application to run on a computer system, and more particularly to dependence analysis by a compiler to determine lack of dependence for loop transformation or automatic parallelization.

2. Description of the Related Art

Computer program applications often execute instructions that create and use large amounts of data. In order to reduce execution time, applications typically attempt to efficiently use computer system resources, such as cache memory and multiple processor configurations. Loop transformation reduces execution time for an application by improving locality as the gap between the microprocessor and memory becomes larger, such as occurs with increased data stores to memory cache to perform large data executions. Similarly, multiprocessor and multi-core microprocessors use automatic parallelization to more effectively use computer system resources for reduced execution time of an application.

In order to obtain effective loop transformation and automatic parallelization, accurate dependence analysis is typically required at compile of the application. Dependence analysis is applied to a target loop nest that generates array subscripts for memory locations to ensure that two array references do not access the same memory location. Array subscript dependence is determined for an original index set of values (i_{—}1, . . . i_n) to an array reference values (j_{—}1, . . . j_n) with an index association and index association function. Accurate dependence analysis determines that dependence exists when two array references are able to access the same memory location. When dependence is found, the application is compiled to preclude incorrect memory accesses by avoiding loop transformation and automatic parallelization, although this results in greater execution times. However, conventional dependence analysis techniques, such as the GCD test and the Fourier-Motzkin test, typically consider only array subscripts that are linear functions of the enclosing loop indices. For more complex array subscripts, such as array subscripts that are non-linear functions of the enclosing loop indices, conventional dependence analysis techniques typically do not attempt a dependence analysis and instead assume that the dependence exists. Assuming dependence for more complex array subscripts during compilation of an application generally results in less use of loop transformation and automatic parallelization even if dependence is lacking. Assuming dependence where it may not exist tends to decrease the efficient use of machine resources and increase execution time for the compiled application.

### SUMMARY OF THE INVENTION

In accordance with the present invention, a method and system are provided to determine whether two array references have dependence. At compile of an application, the compiler analyzes the index association function that maps an original index space to a dependence analysis space to determine whether the index association function uses one-to-one mapping or many-to-one mapping. If the index association function uses many-to-one mapping, then a lack of dependence in the original space is determined by both a lack of dependence in the dependence analysis space and a determination that no two iterations in the original space map to the two array references in the dependence analysis space. If the index association function uses one-to-one mapping, then a determination of no dependence in the dependence analysis space results in a determination of no dependence in the original space. Dependence analysis in the dependence analysis space is performed by determining whether the two references access a memory location in the dependence analysis space. Accurate dependence analysis is provided since any dependence in the dependence analysis space implies dependence in the original space. For many-to-one mapping, a lack of dependence in the dependence analysis space does not guarantee a lack of dependence in the original index space unless, in addition, no two iterations in the original space map to the two references under consideration. The analysis of the index association function as having one-to-one or many-to-one mapping allows accurate dependence analysis where array subscripts are non-linear functions of the enclosing loop indices.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for compiling an application with dependence analysis of array subscripts that are non-linear functions of the enclosing loop indices; and

FIG. 2 depicts a flow diagram of a method for dependence analysis by analysis of index association function mapping.

### DETAILED DESCRIPTION

Execution time for a compiled application is reduced with the present invention by making increased use of loop transformation and automatic parallelization for complex array subscripts including subscripts that result from non-linear function of enclosing loop indices. For instance, during compile of an application, array subscripts that are non-linear functions of the enclosing loop indices are subjected to accurate dependence analysis so that loop transformation and automatic parrallelization may be used where no dependence is found. Accurate dependence analysis for complex array subscripts increases the availability of loop transformation and automatic parrallelization during compilation of an application to result in better application performance at execution.

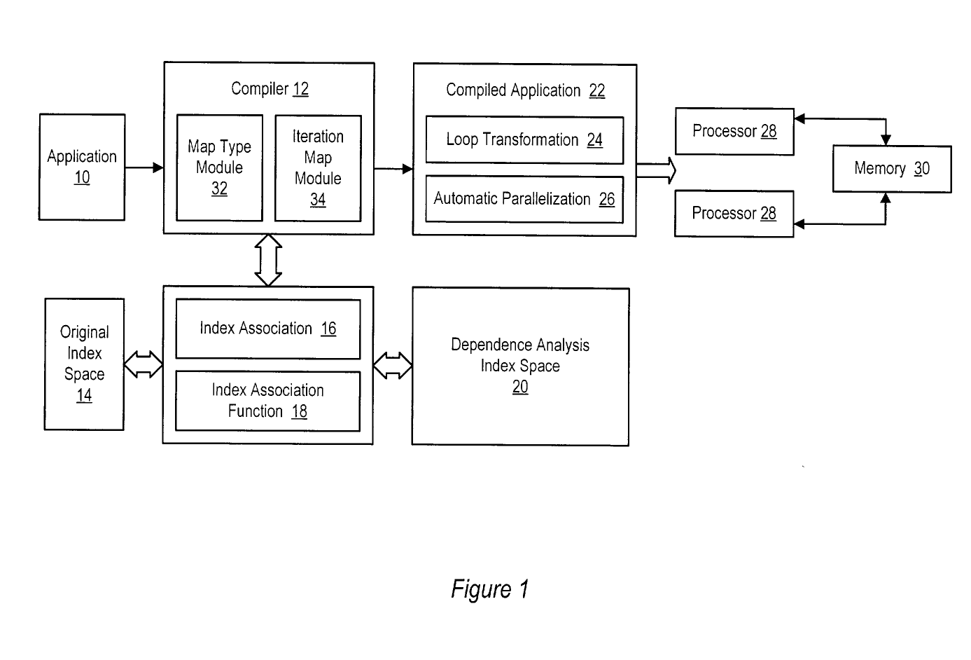

Referring now to FIG. 1, a block diagram depicts a system for compiling an application 10 with dependence analysis of array subscripts that are non-linear functions of the enclosing loop indices. Compiler 12 compiles application 10 with dependence analysis to determine if dependence exists between two array subscript references in an original index space 14 by using an index association 16 and index association function 18 of a dependence analysis index space 20. The compiled application 22 includes loop transformations 24 and automatic parallelizations 26 that coordinate access by one or more processors 28 to memory 30. For instance, large data executions of compiled application 22 access cache memory with improved locality for the gap between processor 28 and memory 30.

As an example, the following perfect loop nest generates array subscript references for cache memory accesses:

do i_1 = l_1, u_1, s_1

so i_2 = l_2, u_2, s_2

* * *

do i_n = l_n, u_n, s_n

j_1 <- f_1 (i_1, . . ., i_n)
j_2 <- f_2 (i_1, . . ., i_n)
* * *

j_n <- f_n (i_1, . . ., i_n)
using linear form of (j_1, . . ., j_n) in array subscripts

end do

* * *

end do

end do

The target loop nest is an n-level perfect nest where n is greater than or equal to one. The loop lower bound l_k, with k greater than or equal to one and less than or equal to n, and upper bound u_k are linear functions of loop indices i_p where p is greater than or equal to one and less than or equal to k−1. The loop steps s_k are loop nest invariants where k is greater than or equal to one and less than or equal to n. In the innermost loop, a set of n functions maps a set of values (i_{—}1, . . . , i_n) in original index space 14 to a new set of values (j_{—}1, . . . , j_n) in dependence analysis space 16. In the rest of the loop body, the linear combination of values (j_{—}1, . . . , j_n) is used in array subscripts. For a given pair of array references, the mapping from the original set of values (i_{—}1, . . . , i_n) to the dependence analysis set of values (j_{—}1, . . . , j_n) is the index association 16 and the function f_k is the index association function 18.

Dependence analysis is applied for two array references by assuming that the dependence analysis space set of values (j_{—}1, . . . , j_n) are loop indices and then analyzing the index association function to determine if the two references have dependence or not. With conventional analysis of an index association function f_k that is a linear function, the index association function is forward substituted into the subscript and the two references are compared to determine dependence should the two subscripts access the same memory location. For example, with the loop nest:

do i = . . .

j = a*i + b
A(c*j+d) = . . .

end do

forward substitution of A(c*j+d) with the index association function becomes A(c*a*i*+c*b+d) where the subscript is a linear function of the loop index value i. In contrast, if the index association function is j=DIV (i,a), because the function is not a linear form of the loop index i after forward substitution, the array reference of c*j+d will not be a linear form of i. Non-linear functions that result before or after a substitution are generally to complex to allow dependence analysis. As another example in which dependence exists for two array references having non-linear functions, with the loop nest:

do i = 1, n

j = DIV (i,2)
A(j) = 5*j

end do

the index association function is not a linear form of the loop index i so that, after forward substitution the function A(j) will not be a linear form of i. This example loop is not a DOALL loop since, as for i=2k and i=2k+1, A(j) accesses the same memory location. Such non-linear functions are typically deemed too complex for analysis by conventional dependence analysis techniques and dependency is generally assumed.

To provide accurate dependence analysis where non-linear functions are involved, the present invention forms an n-dimensional original index space 14 with all combinations of (i_{—}1, . . . , i_n) and an n-dimensional dependence analysis space 20 with all combinations of (j_{—}1, . . . , j_n). The index association functions f_k (k=1, . . . , n) map from the original index space to the dependence analysis space and establish a relationship between the two spaces. The mapping between original index space 14 and dependence analysis space 20 is either one-to-one or many-to-one. Compiler 12 determines whether the mapping is one-to-one or many-to-one with a map type module 32. For one-to-one mapping determinations, the function 18 is dependence for two references under consideration is determined in the dependence analysis space by comparing the subscript values to determine if dependence exists. For many-to-one mapping, in addition to dependence analysis in the dependence analysis space, an iteration map module 34 determines whether any two iterations in original index space 14 could map to the two references under consideration in dependence analysis space 20 respectively. If so, then dependence exists; otherwise no dependence exists.

The determination of one-to-one and many-to-one mapping simplifies dependence analysis by identifying relationships that are capable of being analyzed within a single index space. For instance, with one-to-one mapping any dependence in the dependence analysis index space 20 must mean that dependence exists in the original index space 14 and vice versa. Therefore, when one-to-one mapping is determined, the analysis in the dependence analysis index space 20 will determine dependence or lack of dependence in the original index space as well. In contrast, with many-to-one mapping any dependence in dependence analysis index space 20 implies dependence in original index space 14; however, a lack of dependence in dependence analysis space 20 does not guarantee a lack of dependence in original index space 14. When a lack of dependence is determined in dependence analysis index space 20 for many-to-one mapping, a lack of dependence for the two references is assured by additionally ensuring that no two iterations of original index space 14 map to the two array references under consideration respectively. Consider the above example in which the array reference A(j)=5*j, a many-to-one mapping of original index space (i) to dependence analysis index space (j). No dependence exists between A(j) and itself in dependence analysis index space 20. However, since two adjacent iterations in original index space 14 maps to reference A(j), i.e., the first with the even number and the second with the odd number, there exists a dependence from A(j) to itself in the original index space 14.

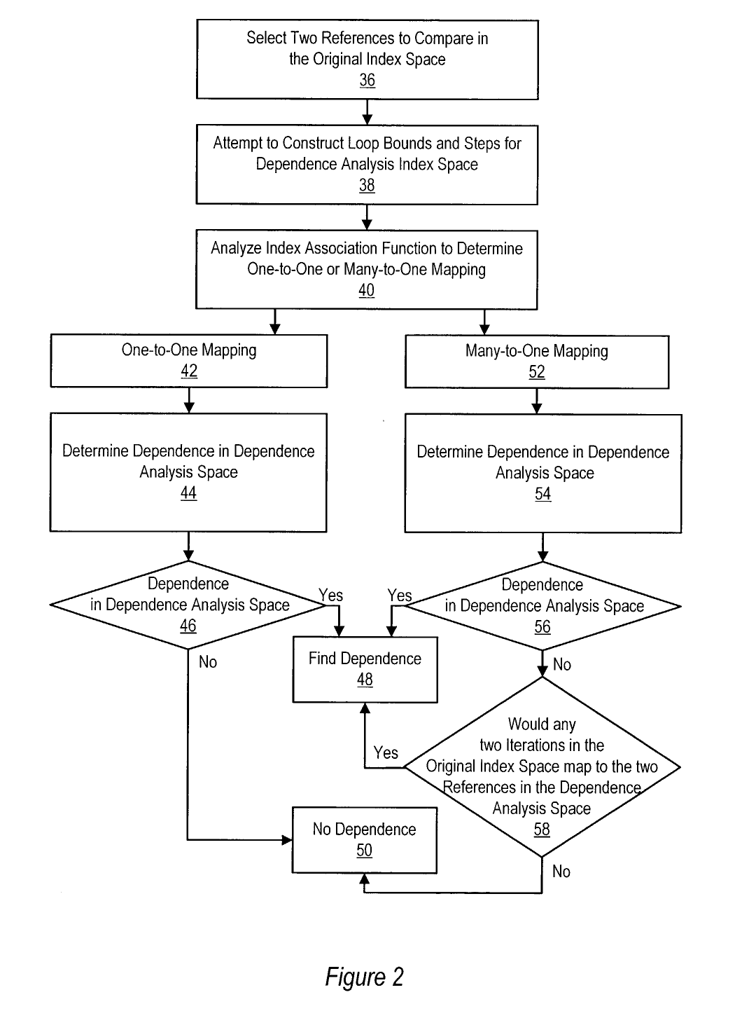

Referring now to FIG. 2, a flow diagram depicts a method for dependence analysis by analysis of index association function mapping. The process begins a step 36 with the selection of two array subscript references for analysis in the original index space. At step 38, an attempt is made to perform conventional dependence analysis but in the dependence analysis space by constructing loop bounds and steps for the dependent analysis index space values of j_{—}1 to j_n. For less complex index association functions, the existence or lack of dependence may be determined from the construction of loop bounds and steps. However, construction of loop bounds and steps may not be feasible with complex index association functions, in which case the process continues.

At step 40, the compiler analyzes the index association functions to determine whether one-to-one or one-to-many mapping exists for the original index i space to the dependence analysis index j space. In the event that one-to-one mapping is determined at step 42, the process proceeds to step 44 for a determination of whether dependence exists or does not exist in the dependence analysis space. At step 46, if dependence exists in either the original index space or the dependence analysis index space, at step 48 dependence is indicated. If at step 46 no dependence exists in either the original index space or the dependence analysis space, then at step 50 no dependence is indicated.

In the event that many-to-one mapping is determined at step 52, the process proceeds to step 54 for a determination of whether dependence exists or does not exist in the dependence analysis index space. At step 56, if dependence exists in the dependence analysis index space, the process proceeds to step 48 to indicate dependence in the original index space as well. If at step 56 dependence is not found in the dependence analysis space, further analysis is required to ensure lack of dependence in the original index space. The process continues to step 58 to determine if any two iterations in the original index space map to the two array subscript references under consideration in the dependence analysis index space. If any two iterations in the original index space could map to the references in the dependence analysis space, the process proceeds to step 48 and dependence is indicated. If no two iterations in the original index space could map to the references in the dependence analysis space, the process proceeds to step 50 to indicate a lack of dependence.

Accurate dependence analysis for complex functions, such as non-linear functions, increases the use of loop transformations parallelization for an application compile. For loop transformation, accurate dependence analysis with a greater number of functional relationships helps to determine the legality of a loop transformation. For automatic parallelization, accurate dependence analysis determines whether or not a loop is a DOALL loop. Further, a determination is possible of proper conditions under which a selected loop is a DOALL loop. Thus, by combining index association-based dependence analysis with conditional parallelization, the compiler is able to parallelize otherwise difficult to parallelize loops. Increased use of loop transformations and automatic parallelization provided improved use of machine resources to allow reduced application execution times.

As an example of the combined use of conditional parallelism and index association function dependence analysis to parallelize a nested loop, consider the nested loop:

do i = 1,n

j = MOD (i,m)
A(j) = 5 * j

end do

Compiler 12 determines that, for values of m greater than or equal to n, mapping from original index space 14 to dependence analysis index space 20 is one-to-one, and otherwise mapping is many-to-one. For one-to-one mapping where m is greater than or equal to n, dependence does not exist and the loop is a DOALL. However, for many-to-one mapping where m is less than n, dependence does exist since the same A(j) could be mapped by two different i values and the loop is not a DOALL. Therefore, to allow conditional parallelization, the loop is translated into:

if (m >=n) then

/* the following loop can be parallelized*/
do i = 1,n

j = MOD (i,m)
A(j) = 5 * j

end do

else

/* the following loop must be serialized*/
do i = 1,n

j = MOD (i,m)
A(j) = 5 * j

end do

end if

The translated loop recognizes the lack of dependence where m is greater than or equal to n to allow parallelization under that condition, and recognizes the existence of dependence where m is less than n to prevent parallelization under that condition.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for determining whether two array references have dependence, the method comprising:
analyzing one or more functions that map an original index space to a dependence analysis space;
determining many-to-one mapping from the original index space to the dependence analysis space;
determining dependence in the original space if dependence exists in the dependence analysis space; and
determining no dependence if no two iterations in the original space map to the two array references in the dependence analysis space.

2. The method of claim 1 wherein the array references comprises loop indices.

3. The method of claim 1 further comprising:
determining one-to-one mapping from the original index space to the dependence analysis space; and
determining no dependence in the original space if no dependence exists in the dependence analysis space.

4. The method of claim 1 wherein one or more of the functions comprise a non-linear function.

5. The method of claim 1 further comprising:
compiling an application for execution on one or more processors, the application using a no dependence determination for accessing memory locations associated with the two array references.

6. The method of claim 5 further comprising:
using the no dependence determination at compile to find a loop transformation as legal to perform.

7. The method of claim 5 further comprising:
using the no dependence determination at compile to find automatic parallelization as legal to perform.

8. The method of claim 7 wherein finding automatic parallelization comprises determining one or more predetermined conditions for parallelization and applying parallelization during execution of the application if the predetermined conditions are met.

9. The method of claim 1 wherein determining dependence in the original space if dependence exists in the dependence analysis space further comprises determining if the two references access the same memory location in the dependence analysis space.

10. A system for determining whether two array references by an application lack dependence, the system comprising:
an application that accesses a memory array with references determined from an index association and an index association function; and
a compiler operable to compile the application with the references identified as either having or lacking dependence, the compiler operable to:
map original index space to dependence analysis index space;
determine whether the map is one-to-one or many-to-one;
determine no dependence in a one-to-one map by determining no dependence in the dependence analysis index space; and
determine no dependence in a many-to-one map by determining no dependence in the dependence analysis index space and by determining that no two iterations in the original index space maps to the references in the dependence analysis index space.

11. The system of claim 10 wherein determining no dependence in a one-to-one map further comprises determining if the two references access the same memory location in the dependence analysis space.

12. The system of claim 10 wherein the index association and the index association function define a perfect loop nest.

13. The system of claim 10 wherein the index association function comprises a non-linear function.

14. The system of claim 10 wherein the compiler is further operable to compile non-dependent references with loop transformation.

15. The system of claim 10 wherein the compiler is further operable to compile non-dependent references with automatic parallelization.

16. A method for compiling an application having memory references determined by an index association that maps a set of i values to a set of j values and a set of index association functions, the method comprising:
forming an n-dimensional index i space representing all combinations of the set of i values i_{—}1 to i_n;
forming an n-dimensional index j space representing all combinations of the set of j values j_{—}1 to j_n;
mapping from the index i space to the index j space with the index association functions;
analyzing the index association functions to determine one-to-one mapping between the index i space and the index j space or to determine many-to-one mapping from the index i space to the index j space;
determining dependence between two memory references if the references have dependence in the index j space;
determining lack of dependence for one-to-one mapping between two memory references that lack dependence in the index j space; and
determining lack of dependence for many-to-one mapping between two memory references unless any two iterations in the index i space could map to the two references in the index j space.

17. The method of claim 16 wherein one or more index association functions map the index i space to the index j space as non-linear functions.

18. The method of claim 16 further comprising:
compiling memory references that lack dependence to use loop transformation.

19. The method of claim 16 further comprising:
compiling memory references that lack dependence to use automatic parallelization.

20. The method of claim 16 further comprising:
compiling memory references that lack dependence to use conditional parallelization.
